(19) United States
(12) Patent Application Publication
(10) Pub. No.: US 2024/0375008 A1
(43) Pub. Date: Nov. 14, 2024

(54) VIRTUAL GOLF SYSTEM AND MANAGEMENT DEVICE

(71) Applicant: JAPAN BRAIN CORPORATION, Tokyo (JP)

(72) Inventor: Kazutaka ONODERA, Tokyo (JP)

(21) Appl. No.: 18/654,067

(22) Filed: May 3, 2024

(30) Foreign Application Priority Data
May 8, 2023 (JP) 2023-076853
Oct. 12, 2023 (JP) 2023-176950

(51) Int. Cl. A63F 13/63; A63F 13/61; A63F 13/812; G06Q 30/0207

(52) U.S. Cl. CPC A63F 13/63; A63F 13/61; A63F 13/812; G06Q 30/0237; A63F 2300/5506

(57) ABSTRACT

A virtual golf system includes: a course creation device that creates original course data representing a virtual golf course on the basis of design information designated by a first user; and a management device that manages a course data group including the original course data and provides, to a simulation device, course data selected from the course data group by a second user who differs from the first user, the simulation device projecting, on a screen, a virtual golf course representing the selected course data and reproducing, on the screen, a trajectory of a golf ball corresponding to a shot hit by the second user, and the management device adds, to the original course data, advertisement data representing an advertisement which is to be placed at a location on the virtual golf course or on an item on the virtual golf course.

This Nonprovisional application claims priority under 35 U.S.C. § 119 on Patent Application No. 2023-076853 filed in Japan on May 8, 2023 and Patent Application No. 2023-176950 filed in Japan on Oct. 12, 2023, the entire contents of which are hereby incorporated by reference.

### TECHNICAL FIELD

The present invention relates to a virtual golf system for reproducing a trajectory of a golf ball corresponding to a shot hit by a user on a virtual golf course.

### BACKGROUND ART

In recent years, virtual golf has become popular in which a shot hit by a user is measured, and a trajectory of a golf ball corresponding to the shot is reproduced on a virtual golf course projected on a screen, so that the user can experience as if he or she is actually playing golf on a golf course. Virtual golf is attractive in that all levels of golfers from beginners to advanced golfers can enjoy virtual golf because, for example, the user can experience playing virtual golf on golf courses all over the world without going to an actual golf course, virtual golf is played indoors and thus is not affected by the weather, and the user can play virtual golf at his or her own timing.

Generally, in virtual golf, a virtual golf course on which virtual golf is to be played is selected from among virtual golf courses registered in a system in advance. This gives rise to, for example, the problem that a course suitable for a user's preference is not registered and the problem that the degree of freedom in selection of a virtual golf course is low. As a result, the user becomes bored as the number of plays increases. Further, virtual golf provides a realistic experience with use of a device such as a high-performance simulation device. This leads to the tendency to increase an introduction cost of the device and a maintenance cost for maintenance and the like. The introduction of the simulation device requires a store property having a high ceiling and a large area. This also contributes to the increase in the introduction cost. As a result, a usage fee of virtual golf is set to be high. This gives rise to the problem of a hindrance to enhancing popularity of virtual golf.

As a technique for solving the problem that a course suitable for a user's preference is not registered or the problem that the degree of freedom in selection of a virtual golf course is low, for example, the technique described in Patent Literature 1 is known. In the technique described in Patent Literature 1, a user selects parameters related to features of a virtual golf course to create a virtual golf course original to the user.

### CITATION LIST

### Patent Literature

### Patent Literature 1

Japanese Patent Application Publication Tokukai No. 2001-120704

### SUMMARY OF INVENTION

### Technical Problem

However, in the above-described technique, there is a restriction that the user (player) can play only in a course in a state in which the user himself/herself has changed course settings that can be selected in advance. Thus, the user himself/herself has to take the trouble to frequently change the course settings. In addition, the problem that the setting of a high usage fee of virtual golf hinders enhancement of popularity of virtual golf still remains unsolved.

The present invention has been made in view of the above problems, and an object of the present invention is to realize a virtual golf system that makes it possible to expand the degree of freedom in selection of a virtual golf course and contribute to a reduction in usage fee of virtual golf.

### Solution to Problem

In order to solve the problems, a virtual golf system in accordance with an aspect of the present invention includes: a course creation device that creates original course data representing a virtual golf course on the basis of design information designated by a first user; and a management device that manages a course data group including the original course data, the management device providing, to a simulation device, course data selected from the course data group by a second user who differs from the first user, the simulation device projecting, on a screen, a virtual golf course representing the selected course data and reproducing, on the screen, a trajectory of a golf ball corresponding to a shot hit by the second user, the management device adding, to the original course data, advertisement data representing an advertisement which is to be placed at a location on the virtual golf course or on an item on the virtual golf course.

In order to solve the problems, a management device in accordance with an aspect of the present invention is a management device that manages a course data group which includes a plurality of pieces of course data each representing a virtual golf course, the management device adding, to course data among the pieces of course data, advertisement data representing an advertisement which is to be placed at a location on a virtual golf course or on an item on the virtual golf course and providing, to a simulation device, course data selected from the course data group by a user, the simulation device projecting, on a screen, a virtual golf course representing the selected course data and reproducing, on the screen, a trajectory of a golf ball corresponding to a shot hit by the user.

### Advantageous Effects of Invention

According to an aspect of the present invention, it is possible to expand the degree of freedom in selection of a virtual golf course and contribute to a reduction in usage fee of virtual golf.

### BRIEF DESCRIPTION OF DRAWINGS

FIG. 1 is a schematic view illustrating a configuration of a virtual golf system in accordance with Embodiment 1.

FIG. 2 is a block diagram illustrating an example of an internal configuration of a management device included in the virtual golf system in accordance with Embodiment 1.

FIG. 3 is a schematic view illustrating an example of a display image that is displayed on a user terminal 1 included in the virtual golf system in accordance with Embodiment 1.

FIG. 4 is a flowchart illustrating an example of a process related to an additional function 1 of the virtual golf system in accordance with Embodiment 1.

FIG. 5 is a flowchart illustrating an example of a process related to an additional function 2 of the virtual golf system in accordance with Embodiment 1.

FIG. 6 is a schematic view illustrating a configuration of a virtual golf system in accordance with Embodiment 2.

FIG. 7 is a block diagram illustrating an example of an internal configuration of a management device included in the virtual golf system in accordance with Embodiment 2.

FIG. 8 is a flowchart illustrating an example of a process in the virtual golf system in accordance with Embodiment 2.

FIG. 9 is a schematic view illustrating an example of use of a virtual golf system in accordance with an embodiment of the present invention.

### DESCRIPTION OF EMBODIMENTS

### Embodiment 1

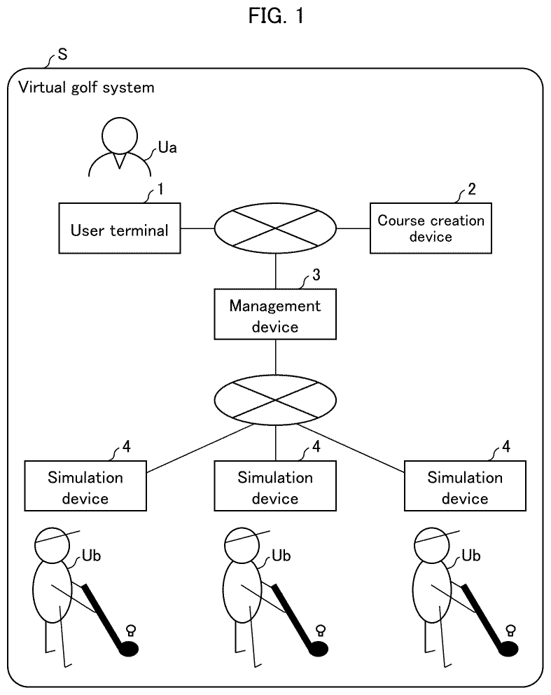

The following will describe an embodiment of the present invention with reference to FIGS. 1 through 6.

### (Outline of Virtual Golf System S)

A virtual golf system S in accordance with an aspect of the present invention is a system that enables a second user Ub who differs from a first user Ua to play virtual golf on a virtual golf course created on the basis of design information designated by the first user Ua.

### (Configuration of Virtual Golf System S)

The configuration of the virtual golf system S will be described with reference to FIG. 1.

As illustrated in FIG. 1, the virtual golf system S includes a user terminal 1, a course creation device 2, a management device 3, and at least one simulation device 4. The user terminal 1 and the course creation device 2 are configured to be capable of communicating with the management device 3 via a network. The simulation device 4 is configured to be capable of communicating with the management device 3 via a network.

The user terminal 1 is possessed by the first user Ua who designs a virtual golf course that can be used in virtual golf. The user terminal 1 receives input of design information by the first user Ua, the design information including information pertaining to at least one selected from the group consisting of a type of a hole of a virtual golf course, a shape and a property of the hole, a shape and a property of a hazard, a shape and a property of an obstacle, and a shape and a property of a message board on which a character string is displayed. In addition, the first user Ua may give any name to the virtual golf course designed by the first user Ua. In this case, the first user Ua inputs, into the user terminal 1, information indicative of a name to be given to the virtual golf course, in addition to the design information.

Here, the “information pertaining to a type of a hole” may be information that is selected by the first user Ua from options such as a short hole, a middle hole, and a long hole or may be information indicative of a hole with a yardage arbitrarily set by the first user Ua. The “information pertaining to a shape and a property of a hole” may be information that is selected by the first user Ua from options such as an inclination of a hole, a width or a length of a fairway, and a width of rough or may be information that is arbitrarily inputted by the first user Ua. The “information pertaining to a shape and a property of a hazard” may be information indicative of a hazard that is selected by the first user Ua from options such as a tree, a bunker, a pond, and a road and that has a size and a position which are arbitrarily set by the first user Ua. The “information pertaining to a shape and a property of an obstacle” may be information indicative of an obstacle that is selected by the first user Ua from options such as a flag and a color cone (registered trademark) and that has a size and a position which are arbitrarily set by the first user Ua. The “information pertaining to a shape and a property of a message board on which a character string is displayed” may be information such that a size and a position of a message board and a message to be displayed on the message board are arbitrarily set by the first user Ua. Specific examples of the message include “Happy Birthday” and the like. Note that the information included in the design information is not limited to the information described above. For example, information pertaining to the weather, information pertaining to a distant landscape, and the like information may be included in the design information.

In addition, the user terminal 1 transmits, to the course creation device 2, the above-described design information that has been inputted by the first user Ua. Note that, in the present embodiment, a desktop personal computer (PC) possessed by the first user Ua is used as the user terminal 1, but the present invention is not limited thereto. For example, a smartphone, a tablet terminal, or the like may be used as the user terminal 1.

The course creation device 2 creates original course data representing a virtual golf course on the basis of the design information that has been designated by the first user Ua and received from the user terminal 1. In addition, the course creation device 2 transmits, to the management device 3, the created original course data and information pertaining to the first user Ua. In the present embodiment, the course creation device 2 is placed outside a facility where virtual golf is played. As an example, the course creation device 2 is placed in a data center. Examples of a device that can be used as the course creation device 2 include a work station that constitutes a cloud server.

The management device 3 manages a course data group including the original course data that has been received from the course creation device 2. In addition, the management device 3 extracts course data from the course data group on the basis of a signal received from the simulation device 4, which will be described later, and transmits the extracted course data to the simulation device 4. In the present embodiment, the management device 3, like the course creation device 2, is placed outside the facility where virtual golf is played. Thus, the course creation device 2 and the management device 3 may be placed in the same place or may be placed in respectively different places. Examples of a device that can be used as the management device 3 include a work station that constitutes a cloud server.

The simulation device 4 is placed in the facility where virtual golf can be played, and is operated by a second user Ub who plays virtual golf. Here, it is assumed that the second user Ub is a user who differs from the first user Ua who designs the virtual golf course. However, the first user Ua and the second user Ub may be the same user. The second user Ub inputs, into the simulation device 4, an operation of selecting course data representing a virtual golf course on which virtual golf is to be played from the course data group stored in the management device 3. Upon receipt of a selection of the course data made by the second user Ub, the simulation device 4 transmits, to the management device 3, a signal for instructing the management device 3 to transmit the selected course data. In addition, the simulation device 4 projects, on a screen, the virtual golf course represented by the course data which has been received from the management device 3 and reproduces a trajectory of a golf ball corresponding to a shot hit by the second user Ub and projects the trajectory on the screen. In the present embodiment, a known device placed in the facility where virtual golf is played is used as the simulation device 4.

A network for connecting the above-described devices can be arbitrarily selected. Examples of a network that can be used include a personal area network (PAN), a local area network (LAN), a campus area network (CAN), a metropolitan area network (MAN), a wide area network (WAN), a global area network (GAN), and an internetwork including any of such networks. The internetwork may be an intranet, an extranet, or the Internet.

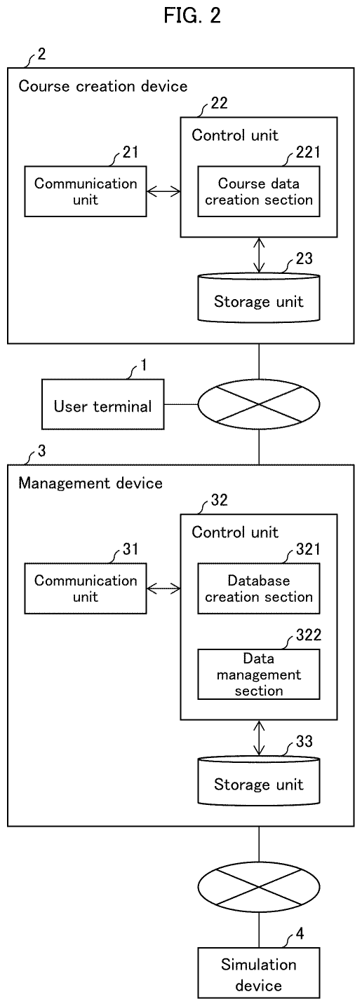

The above-described devices that constitute the virtual golf system S will be described in detail with reference to FIG. 2. FIG. 2 is a block diagram illustrating an example of internal configurations of the devices included in the virtual golf system S. Note that, in the present embodiment, known devices are used as the user terminal 1 and the simulation device 4, and thus descriptions thereof will be omitted below.

### (Configuration of Course Creation Device 2)

As illustrated in FIG. 2, the course creation device 2 includes a communication unit 21, a control unit 22, and a storage unit 23.

### [Communication Unit 21]

The communication unit 21 communicates with the user terminal 1 and the management device 3 via a network. As an example, the communication unit 21 receives, from the user terminal 1, design information designated by the first user Ua. In addition, the communication unit 21 transmits, to the management device 3, information pertaining to the first user Ua and original course data created on the basis of the design information designated by the first user Ua.

### [Control Unit 22]

The control unit 22 includes a central processing unit (CPU). The CPU executes a control program (not illustrated) which is stored in the storage unit 23 to control constituent elements included in the course creation device 2. Further, the control unit 22 includes a course data creation section 221.

The course data creation section 221 creates course data representing a virtual golf course. As an example, the course data creation section 221 creates original course data representing a virtual golf course that reflects design information designated by the first user Ua and received from the user terminal 1.

### [Storage Unit 23]

The storage unit 23 stores various kinds of information. As an example, the storage unit 23 stores design information and information pertaining to the first user Ua, which have been received from the user terminal 1, and original course data created on the basis of the design information which has been received from the user terminal 1. In addition, the storage unit 23 stores not only the above-described information but also information related to all processes carried out by the course creation device 2.

In the present embodiment, the configuration in which original course data is automatically created on the basis of design information which has been received from the user terminal 1 is employed for the course creation device 2, but the present invention is not limited thereto. Alternatively, a configuration may be employed in which a service provider (for example, an owner of the virtual golf system S) inputs, into the course creation device 2, design information obtained by conducting a hearing with the first user Ua, and original course data is created on the basis of the inputted design information. In this case, the course creation device 2 needs to further include an input unit for receiving input of the design information by the service provider and a display unit for displaying a preview image based on the inputted design information.

### (Configuration of Management Device 3)

The following will describe a configuration of the management device 3 by continuously referring to FIG. 2.

As illustrated in FIG. 2, the management device 3 includes a communication unit 31, a control unit 32, and a storage unit 33.

### [Communication Unit 31]

The communication unit 31 communicates with the user terminal 1 and the course creation device 2 via a network and communicates with the simulation device 4 via a network. As an example, the communication unit 31 receives, from the course creation device 2, information pertaining to the first user Ua and original course data created on the basis of design information designated by the first user Ua. Further, the communication unit 31 receives, from the simulation device 4, a signal for providing an instruction for transmitting course data representing a virtual golf course which has been selected by the second user Ub, and transmits the course data to the simulation device 4.

### [Control Unit 32]

The control unit 32 includes a CPU. The CPU executes a control program (not illustrated) which is stored in the storage unit 33 to control constituent elements included in the management device 3. Further, the control unit 32 includes a database creation section 321 and a data management section 322.

The database creation section 321 creates (updates) various databases. As an example, the database creation section 321 creates (updates) a course information database that is a course data group including data in which original course data received from the course creation device 2 is associated with information pertaining to the first user Ua who has designated design information on which the original course data is based. Note that the course information database may include course data representing a virtual golf course that imitates an actually existing golf course.

The data management section 322 extracts information from various databases. As an example, on the basis of a signal, received from the simulation device 4, for providing an instruction for transmitting course data representing a virtual golf course which has been selected by the second user Ub, the data management section 322 extracts the course data from the course information database and transmits the extracted course data to the simulation device 4. In addition, the data management section 322 carries out data processing based on data extracted from various databases.

### [Storage Unit 33]

The storage unit 33 stores various kinds of information. As an example, the storage unit 33 stores the course information database and information indicative of a history record of a virtual golf course which has been selected by the second user Ub. Further, the storage unit 33 stores not only the above-described example information but also information related to all processes carried out by the management device 3.

### (Processes Carried Out by Virtual Golf System S)

### [Course Creation Process]

A course creation process carried out by the virtual golf system S to create a virtual golf course based on design information designated by the first user Ua will be described.

First, the user terminal 1 receives input of design information by the first user Ua, the design information including information pertaining to at least one selected from the group consisting of a type of a hole of a virtual golf course, a shape and a property of the hole, a shape and a property of a hazard, a shape and a property of an obstacle, and a shape and a property of a message board on which a character string is displayed. The user terminal 1 having received the input transmits, to the course creation device 2, the design information.

The course creation section 221 of the course creation device 2 creates original course data representing a virtual golf course on the basis of the received design information.

The database creation section 321 of the management device 3 records, in the course information database, information in which the original course data created by the course creation device 2 and the first user Ua who has inputted the design information on which the original course data is based are associated with each other. This enables the second user Ub who plays virtual golf to select the virtual golf course created on the basis of the design information designated by the first user Ua.

### [Virtual Golf Course Provision Process]

A virtual golf course provision process of providing course data representing a virtual golf course to the simulation device 4 in order for the second user Ub to play virtual golf will be described.

First, the simulation device 4 receives a selection of a virtual golf course by the second user Ub. At this time, the simulation device 4 transmits, to the management device 3, a signal for providing an instruction for transmitting course data representing the selected virtual golf course.

The data management section 322 of the management device 3 extracts the course data representing the selected virtual golf course from the course information database stored in the storage unit 33.

The communication unit 31 of the management device 3 transmits, to the simulation device 4, the course data, which has been extracted from the course information database, representing the virtual golf course selected by the second user Ub. This enables the second user Ub to play virtual golf on the virtual golf course selected by the second user Ub.

### Display Example

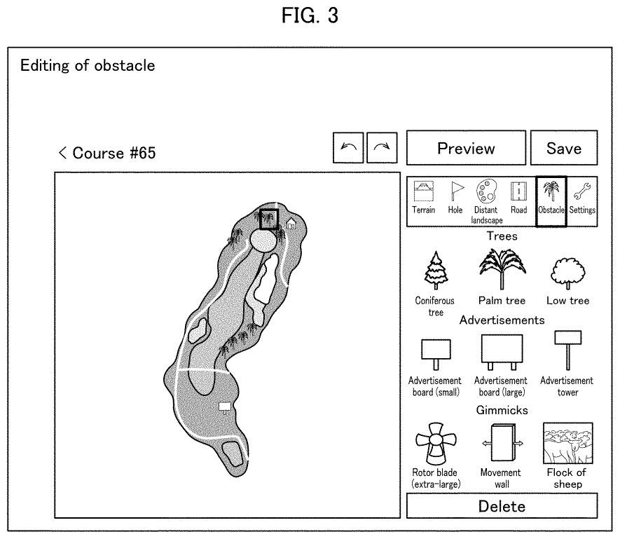

A display screen that is displayed on the user terminal 1 when the first user Ua inputs design information into the user terminal 1 will be described with reference to FIG. 3. FIG. 3 is a view illustrating an example of a display image that is displayed on the display unit of the user terminal 1 when the first user Ua inputs design information.

In the example of the display image illustrated in FIG. 3, options for an obstacle to be placed on a virtual golf course and the virtual golf course reflecting inputted design information are illustrated. As an example, the first user Ua inputs, into the user terminal 1, information pertaining to the shape or the property of an obstacle by an operation of dragging and dropping an obstacle from the options for the obstacle.

### (Additional Function 1)

A virtual golf system S in accordance with the present embodiment may have a function of awarding a point to the first user Ua when the virtual golf course created on the basis of design information designated by the first user Ua is selected by the second user Ub who differs from the first user Ua. In order to exhibit this function, the database creation section 321 of the management device 3 creates (updates) a point database that includes data in which the first user Ua and earned points are associated with each other.

Note that the point awarded here may be, for example, a point that can be converted into cash to redeem for a cost of creating another virtual golf course and a discount on a usage fee of virtual golf or may be a point that can be exchanged for golf goods or the like.

### [Point Awarding Process]

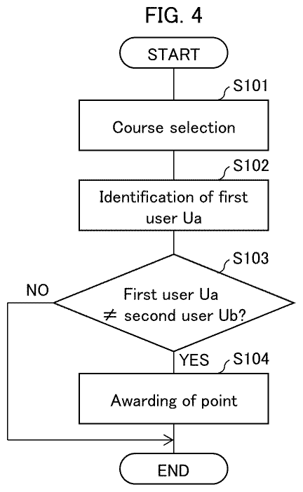

A flow of a point awarding process carried out by the virtual golf system S will be described with reference to FIG. 4. The point awarding process is carried out in parallel with the process, which is carried out by the above-described virtual golf system S, for enabling the second user Ub to play virtual golf. FIG. 4 is a flowchart illustrating the flow of the point awarding process carried out by the virtual golf system S.

First, the simulation device 4 receives a selection of a virtual golf course by the second user Ub (step S101: course selection). At this time, the simulation device 4 transmits, to the management device 3, a signal for providing an instruction for transmitting course data representing the selected virtual golf course.

The data management section 322 of the management device 3 refers to the course information database for the course data representing the virtual golf course selected by the second user Ub and identifies the first user Ua associated with the course data (step S102: identification of the first user Ua).

The data management section 322 of the management device 3 determines whether the identified first user Ua differs from the second user Ub (step S103).

In a case where the identified first user Ua differs from the second user Ub (YES in step S103), the data management section 322 of the management device 3 updates the point database (step S104: awarding of point). In a case where the identified first user Ua is identical to the second user Ub (NO in step S103), the process is ended without updating the point database.

Note that the first user Ua can check his/her own earned points. In this case, the first user Ua operates the user terminal 1 to cause the user terminal 1 to transmit, to the management device 3, a signal for requesting permission to view the earned points. The management device 3 that has received the signal refers to the point database for the earned points of the first user Ua and transmits, to the user terminal 1, information pertaining to the earned points.

### (Additional Function 2)

The virtual golf system S in accordance with the present embodiment may have a function of placing an advertisement on a virtual golf course created on the basis of design information designated by the first user Ua. In addition, the virtual golf system S may have a function of, when a virtual golf course on which an advertisement is placed has been selected by the second user Ub who differs from the first user Ua, paying the first user Ua a reward commensurate with an advertisement fee of the placed advertisement. In order to exhibit these functions, the database creation section 321 of the management device 3 creates an advertisement database that includes data in which advertisement data representing an advertisement placed on a virtual golf course and information indicative of an advertisement fee are associated with each other and a reward database in which the first user Ua and a reward amount to be paid are associated with each other.

A process carried out by the virtual golf system S to exhibit the above-described functions will be described.

### [Course Creation Process]

A course creation process carried out by the virtual golf system S to create a virtual golf course on which an advertisement can be placed will be described.

First, the first user Ua inputs, into the user terminal 1, design information that includes information indicative of a location where an advertisement is to be placed on a virtual golf course or an item where an advertisement is to be placed on a virtual golf course. For example, the first user Ua selects a location where an advertisement is to be placed from a green, a fairway, a tree, a side of a bunker, a rough, and the like or selects an item where an advertisement is to be placed from an airship, a balloon, a pin, a flag, and the like. Further, the design information inputted by the first user Ua may include, in addition to the information indicative of a location where an advertisement is to be placed or the item where an advertisement is to be placed, information indicative of a size or the like of an advertisement to be placed.

The course creation section 221 of the course creation device 2 creates original course data representing a virtual golf course on the basis of the inputted design information. Note that the original course data created here is in a state where advertisement data indicative of an advertisement to be placed on a virtual golf course is not present.

The database creation section 321 of the management device 3 records, in the course information database, information in which the created original course data and the first user Ua who has inputted the design information on which the original course data is based are associated with each other. This enables the second user Ub who plays virtual golf to select a virtual golf course on which an advertisement is placed.

### [Reward Amount Calculation Process]

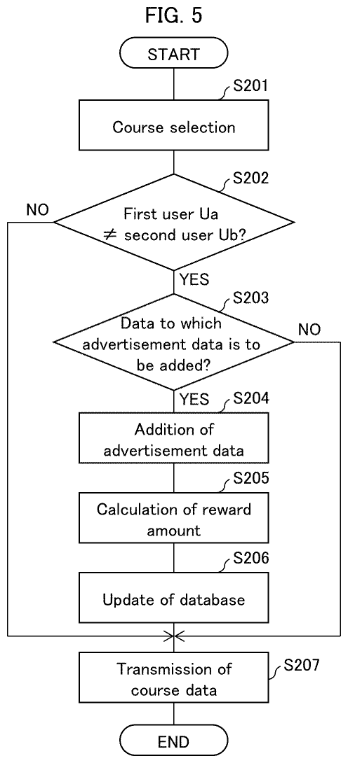

A reward amount calculation process that is carried out by the virtual golf system S to calculate a reward amount to be paid to the first user Ua will be described with reference to FIG. 5. FIG. 5 is a flowchart illustrating a flow of the reward amount calculation process carried out by the virtual golf system S.

First, the simulation device 4 receives a selection of a virtual golf course by the second user Ub (step S201: course selection). At this time, the simulation device 4 transmits, to the management device 3, a signal for providing an instruction for transmitting course data representing the selected virtual golf course.

The data management section 322 of the management device 3 extracts the course data representing the virtual golf course selected by the second user Ub from the course information database stored in the storage unit 33 and determines whether the first user Ua associated with the extracted course data differs from the second user Ub (step S202: determination on whether the first user Ua≠the second user Ub). In a case where the first user Ua=the second user Ub (NO in step S202), the process proceeds to step S207.

In a case where the first user Ua≠the second user Ub (YES in step S202), the data management section 322 further determines whether the course data extracted in step S202 is course data to which advertisement data is to be added (step S203: determination on the presence or absence of an advertisement placed). In a case where the extracted course data is not data to which advertisement data is to be added (NO in step S203), the process proceeds to step S207.

In a case where the extracted course data is data to which advertisement data is to be added (YES in step S203), the data management section 322 extracts advertisement data indicative of an advertisement to be placed from the advertisement database, and adds the advertisement data to the extracted course data (step S204: addition of advertisement data).

The data management section 322 calculates a reward amount on the basis of information indicative of an advertisement fee corresponding to the advertisement data that has been added in step S204 (step S205: calculation of reward amount).

The database creation section 321 of the management device 3 updates a reward database stored in the storage unit 33 on the basis of the reward amount that has been calculated in step S205 (step S206: update of database).

The communication unit 31 of the management device 3 transmits, to the simulation device 4, the course data to which the advertisement data has been added in step S204 (step S207: transmission of course data).

Note that the virtual golf system S may have both the above-described additional function 1 and the above-described additional function 2 or may have only one selected from the group consisting of the above-described additional function 1 and the above-described additional function 2. In addition, in the additional functions, it is assumed that the owner of the virtual golf course on which the advertisement is placed is the first user who has designed the virtual golf course. However, the present invention is not limited thereto. For example, the first user Ua who has designed the virtual golf course can transfer the ownership of the virtual golf course to a third user. In this case, the original course data created on the basis of the design information designated by the first user Ua, the information pertaining to the first user Ua, and information pertaining to the third user to whom the first user Ua has transferred the ownership are associated with each other and recorded in the course information database. In a case where a reward is generated, the reward may be paid to the first user Ua or the third user on the basis of the information recorded in the course information database. Further, the first user Ua can grant a right to use the virtual golf course to a fourth user. In this case, the original course data created on the basis of the design information designated by the first user Ua, the information pertaining to the first user Ua, and information pertaining to the fourth user to whom the right to use the virtual golf course has been granted by the first user Ua are associated with each other and recorded in the course information database. In a case where a reward is generated, the reward may be paid to the first user Ua or the fourth user on the basis of the information recorded in the course information database.

(Effect Brought about by Virtual Golf System S)

According to the virtual golf system S, it is possible to realize a virtual golf system that expands the degree of freedom in selection of a virtual golf course.

In particular, employing a configuration which enables a virtual golf course created on the basis of the design information designated by the first user Ua to be selected and played by the second user Ub who differs from the first user Ua expands the degree of freedom in selection of a virtual golf course.

In addition, the virtual golf system S also brings about an effect that the function of awarding a point and the additional 1 function of placing an advertisement promote the design of the virtual golf course by the first user Ua and further expand the degree of freedom in selection of the virtual golf course.

### Embodiment 2

The following will describe another embodiment of the present invention. For convenience of description, members having the same functions as those of the members described in Embodiment 1 are given the same reference numerals, and description thereof will not be repeated.

### (Outline of Virtual Golf System S1)

A virtual golf system S1 in accordance with the present embodiment is a system in which an advertisement is placed on a virtual golf course on which virtual golf can be played.

### (Configuration of Virtual Golf System S1)

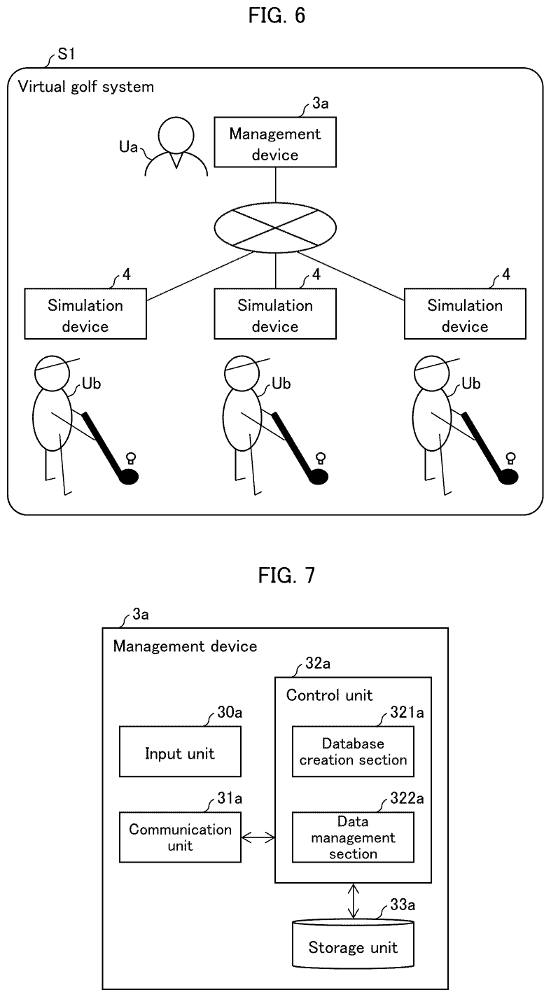

A configuration of the virtual golf system S1 will be described with reference to FIG. 6. FIG. 6 is a schematic view illustrating the configuration of the virtual golf system S1.

As illustrated in FIG. 6, the virtual golf system S1 includes a management device 3a, and at least one simulation device 4. The management device 3a is configured to be capable of communicating with the simulation device 4 via a network.

The management device 3a manages a course data group that includes course data representing a virtual golf course on which virtual golf can be played. In addition, the management device 3a extracts course data from the course data group on the basis of a signal received from the simulation device 4, and transmits the extracted course data to the simulation device 4. In the present embodiment, the management device 3a is placed outside a facility where virtual golf is played. Examples of a device that can be used as the management device 3a include a work station that constitutes a cloud server.

### (Configuration of Management Device 3a)

A configuration of the management device 3a will be described with reference to FIG. 7. FIG. 7 is a block diagram illustrating an example of an internal configuration of the management device 3a.

As illustrated in FIG. 7, the management device 3a includes an input unit 30a, a communication unit 31a, a control unit 32a, and a storage unit 33a.

[Input Unit 30a]

The input unit 30a receives an input operation carried out with respect to the management device 3 by another user Ua. As an example, the input unit 30a receives, from the another user Ua, input of course data representing a virtual golf course, advertisement placement information, and information pertaining to the another user Ua. Here, the “advertisement placement information” is information including information indicative of a location where an advertisement is to be placed or an item where an advertisement is to be placed. For example, the another user Ua selects a location where an advertisement is to be placed from a green, a fairway, a tree, a side of a bunker, a rough, and the like or selects an item where an advertisement is to be placed from an airship, a balloon, a pin, a flag, and the like to input, into the input unit 30a, the information indicative of a location where an advertisement is to be placed or an item where an advertisement is to be placed. Further, the advertisement placement information inputted by the another user Ua may include, in addition to the information indicative of a location where an advertisement is to be placed or the item where an advertisement is to be placed, information indicative of a size or the like of an advertisement to be placed.

[Communication Unit 31a]

The communication unit 31a communicates with the simulation device 4 via a network. As an example, the communication unit 31a receives, from the simulation device 4, a signal for providing an instruction for transmitting course data representing a virtual golf course which has been selected by a user Ub who plays virtual golf, and transmits the course data to the simulation device 4.

[Control Unit 32a]

The control unit 32a includes a CPU. The CPU executes a control program (not illustrated) which is stored in the storage unit 33a to control constituent elements included in the management device 3a. Further, the control unit 32a includes a database creation section 321a and a data management section 322a.

The database creation section 321a creates (updates) various databases. As an example, the database creation section 321a creates (updates): a course information database which is a course data group that includes data in which course data representing a virtual golf course, information pertaining to the another user Ua, and advertisement placement information inputted by the another user Ua are associated with each other; an advertisement database that includes data in which advertisement data indicative of an advertisement to be placed on a virtual golf course and an advertisement fee are associated with each other; and a reward database in which the another user Ua and a reward amount to be paid are associated with each other. Note that the course data included in the course information database may be course data representing a virtual golf course imitating an actually existing golf course, or may be course data representing an imaginary golf course. In the present embodiment, the another user Ua is assumed to be a creator of course data or a user (for example, a service provider) who places an advertisement in existing course data. Examples of the service provider include a manufacturer of a device used for virtual golf.

The data management section 322a extracts information from various databases. As an example, on the basis of a signal, received from the simulation device 4, for providing an instruction for transmitting course data representing a virtual golf course which has been selected by the user Ub, the data management section 322a extracts course data and advertisement placement information from the course information database and extracts advertisement data and information pertaining to an advertisement fee from the advertisement database. In addition, the data management section 322a carries out data processing based on extracted data. As an example, the data management section 322a carries out a process of adding advertisement data to the course data on the basis of the advertisement placement information and a process of calculating a reward amount on the basis of information indicative of an advertisement fee.

[Storage Unit 33a]

The storage unit 33a stores various kinds of information. As an example, the storage unit 33a stores various databases such as the course information database, the advertisement database, and the reward database. Further, the storage unit 33a stores not only the above-described example information but also information related to all processes carried out by the management device 3a.

### (Processes Carried Out by Virtual Golf System S1)

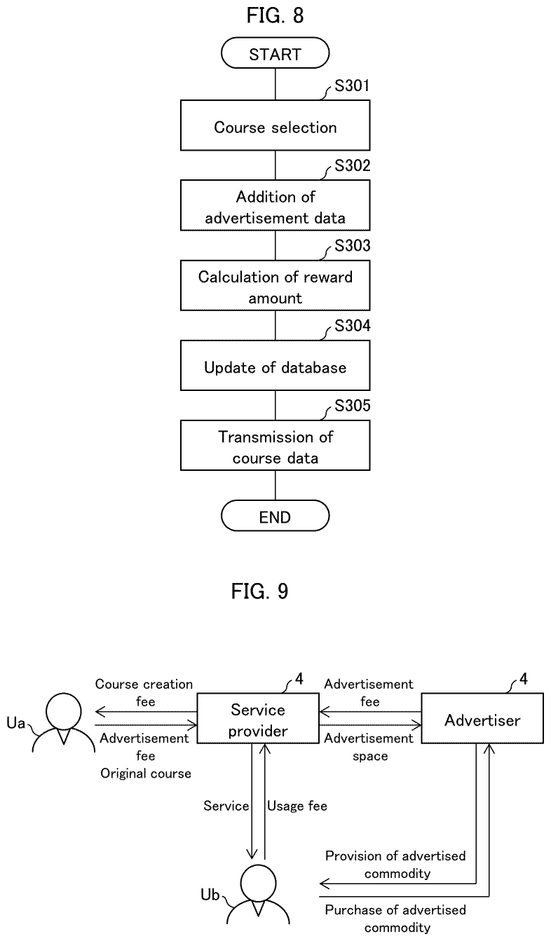

A reward amount calculation process that is carried out by the virtual golf system S1 to calculate a reward amount to be paid to an owner of course data representing a virtual golf course will be described with reference to FIG. 8. FIG. 8 is a flowchart illustrating a flow of the reward amount calculation process carried out by the virtual golf system S1.

### [Reward Calculation Process]

First, the simulation device 4 receives a selection of a virtual golf course by the user Ub (step S301: course selection). At this time, the simulation device 4 transmits, to the management device 3a, a signal for providing an instruction for transmitting course data representing the selected virtual golf course.

The data management section 322a of the management device 3a extracts, from the course information database stored in the storage unit 33a, the course data representing a virtual golf course selected by the user Ub and the advertisement placement information and adds, on the basis of the advertisement placement information, the advertisement data extracted from the advertisement database (step S302: addition of advertisement data).

The data management section 322a calculates a reward amount on the basis of information indicative of an advertisement fee corresponding to the advertisement data that has been added in step S302 (step S303: calculation of reward amount).

The database creation section 321a of the management device 3a updates a reward database stored in the storage unit 33a on the basis of the reward amount that has been calculated in step S303 (step S304: update of database).

The communication unit 31 of the management device 3a transmits, to the simulation device 4, the course data that has been extracted in step S302 (step S305: transmission of course data).

(Effect Brought about by Virtual Golf System S1)

According to the virtual golf system S1, it is possible to realize a virtual golf system that contributes to a reduction in a usage fee of virtual golf.

In particular, by employing a configuration in which a reward commensurate with an advertisement fee of an advertisement placed on a virtual golf course is paid to a service provider or the like that is the another user Ua, an income other than the usage fee of virtual golf is expected, and as a result, it is possible to contribute to a reduction in the usage fee of virtual golf. In addition, there is a possibility that the reduction in the usage fee further enhances popularity of virtual golf.

### Example of Use of Virtual Golf System

An example of use of the virtual golf system will be described with reference to FIG. 9. FIG. 9 is a schematic view illustrating an example of a business model of the virtual golf system S.

As illustrated in FIG. 9, the virtual golf system S is applicable to a business model in which an advertisement is placed on a virtual golf course that is created on the basis of design information designated by the first user Ua, and an advertisement fee is paid from an advertiser to the first user Ua and a service provider (for example, an owner of a virtual golf system or the like) in accordance with, for example, the number of times the course has been selected by the user Ub.

Although not illustrated, the virtual golf system S1 is applicable to a business model in which, in accordance with the number of times a virtual golf course on which an advertisement is placed has been selected by the user Ub, an advertisement fee is paid from an advertiser to a service provider that is an owner of the course (for example, an owner of a virtual golf system or the like).

### Software Implementation Example

The functions of the course creation device 2, the management device 3, and the management device 3a (hereinafter referred to as “device”) can be realized by a program for causing a computer to function as the device, the program causing the computer to function as control blocks (in particular, the sections included in the control units 22, 32, and 32a).

In this case, the device includes, as hardware for executing the program, a computer that includes at least one control device (e.g., a processor) and at least one storage device (e.g., a memory). By the control device executing the program with use of the storage device, the functions described in the foregoing embodiments are realized.

The program can be stored in at least one computer-readable non-transitory storage medium. The storage medium can be provided in the device, or the storage medium does not need to be provided in the device. In the latter case, the program can be supplied to the device via an arbitrary wired or wireless transmission medium.

Further, one or some or all of respective functions of the control blocks described above can be realized by a logic circuit. For example, an integrated circuit in which a logic circuit that functions as each of the control blocks is formed is also encompassed in the scope of the present invention. In addition, it is also possible to realize each of the control blocks by, for example, a quantum computer.

### [Additional Remark]

The present t invention is not limited to the embodiments, but can be altered by a skilled person in the art within the scope of the claims. The present invention also encompasses, in its technical scope, any embodiment derived by combining technical means disclosed in differing embodiments.

Aspects of the present invention can also be expressed as follows:

A virtual golf system in accordance with Aspect 1 of the present embodiment includes: a course creation device that creates original course data representing a virtual golf course on the basis of design information designated by a first user; a management device that manages a course data group including the original course data; and a simulation device that projects, on a screen, a virtual golf course representing course data selected from the course data group by a second user who differs from the first user and that reproduces, on the screen, a trajectory of a golf ball corresponding to a shot hit by the second user.

According to the above-described configuration, it is possible to create the original course data based on the design information designated by the first user and allow the second user who differs from the first user to play a virtual golf course represented by that course data. This makes it possible to expand the degree of freedom in selection of a virtual golf course on which virtual golf can be played in a virtual golf system.

The virtual golf system in accordance with Aspect 2 of the present embodiment is configured such that in the Aspect 1 above, the design information includes information pertaining to at least one selected from the group consisting of a type of a hole, a shape and a property of the hole, a shape and a property of a hazard, and a shape and a property of an obstacle.

According to the above-described configuration, it is possible to freely designate, for example, the type of the hole, the shape and the property of the hole, the shape and the property of the hazard, and the shape and the property of the obstacle. Thus, it is possible to reproduce, with higher accuracy, a course which the first user wants to design.

The virtual golf system in accordance with Aspect 3 of the present embodiment is configured such that in Aspect 1 or 2 above, the management device adds, to the original course data, advertisement data representing an advertisement which is to be placed on the virtual golf course.

According to the above-described configuration, it is possible to place an advertisement on a virtual golf course designed by the first user.

The virtual golf system in accordance with Aspect 4 of the present embodiment is configured such that in Aspect 3 above, when the original course data including the advertisement data has been selected by the second user, the management device calculates a reward amount commensurate with an advertisement fee as a reward amount to be paid to the first user or a third user to whom ownership of the original course data has been transferred from the first user.

According to the above-described configuration, it is possible to allow the first user to obtain an income derived from the second user selecting a virtual golf course on which an advertisement is placed and which has been designed by the first user.

The virtual golf system in accordance with Aspect 5 of the present embodiment is configured such that in Aspect 3 or 4 above, the design information includes information indicative of a location where the advertisement is to be placed.

According to the above-described configuration, it is possible to allow the first user to place an advertisement at an arbitrary position on a virtual golf course. Thus, it is possible to conspicuously place the advertisement or place the advertisement at a position where the advertisement does not interfere with a play. This achieves a high degree of freedom in placement of an advertisement.

The virtual golf system in accordance with Aspect 6 of the present embodiment is configured such that in any one of Aspects 1 to 5 above, when the original course data has been selected by the second user, the management device awards a point to the first user.

According to the above-described configuration, it is possible to allow the first user to earn a point that can be used in a virtual golf system each time a virtual golf course designed by the first user is selected by the second user.

The virtual golf system in accordance with Aspect 7 of the present embodiment includes: a management device that manages a course data group which includes a plurality of pieces of course data each representing a virtual golf course, the management device adding, to course data among the pieces of course data, advertisement data representing an advertisement which is to be placed on a virtual golf course; and a simulation device that projects, on a screen, a virtual golf course representing course data selected from the course data group by the second user and that reproduces, on the screen, a trajectory of a golf ball corresponding to a shot hit by the user.

According to the above-described configuration, it is possible to place an advertisement on a virtual golf course that can be used in virtual golf. Thus, it is possible to promote the sales of a commodity for which an advertisement is placed.

The virtual golf system in accordance with Aspect 8 of the present embodiment is configured such that in Aspect 7 above, the management device adds the advertisement data to the course data on the basis of advertisement placement information designated by another user who differs from the user.

According to the above-described configuration, it is possible to allow another user to freely designate advertisement placement. Thus, it is possible to adjust advertisement placement with a high degree of freedom such that, for example, an advertisement is placed on a course where an advertisement is desired to be placed or that no advertisement is placed on a course where any advertisement is not desired to be placed.

The virtual golf system in accordance with Aspect 9 of the present embodiment is configured such that in Aspect 8 above, the advertisement placement information includes information indicative of a location where an advertisement is to be placed on the virtual golf course or an item where an advertisement is to be placed on the virtual golf course.

According to the above-described configuration, it is possible to allow another user to designate, for example, a location where an advertisement is to be placed or an item on which an advertisement is to be placed. Thus, it is possible to take a measure such as setting of an advertisement at a position where the user can easily see the advertisement. This makes is possible to achieve further sales promotion of an advertised commodity.

The virtual golf system in accordance with Aspect 10 of the present embodiment is configured such that in Aspect 8 or 9 above, when the course data including the advertisement data has been selected by the user, the management device calculates a reward amount commensurate with an advertisement fee as a reward amount to be paid to the another user.

According to the above-described configuration, it is possible to obtain an income derived from selection of a virtual golf course by a user.

### REFERENCE SIGNS LIST

1: user terminal
2: course creation device
3, 3a: management device
4: simulation device

1. A virtual golf system comprising:
a course creation device that creates original course data representing a virtual golf course on the basis of design information designated by a first user; and
a management device that manages a course data group including the original course data, the management device providing, to a simulation device, course data selected from the course data group by a second user who differs from the first user, the simulation device projecting, on screen, a virtual golf course representing the selected course data and reproducing, on the screen, a trajectory of a golf ball corresponding to a shot hit by the second user,
the management device adding, to the original course data, advertisement data representing an advertisement which is to be placed at a location on the virtual golf course or on an item on the virtual golf course.

2. The virtual golf system according to claim 1, wherein:
the design information includes information pertaining to at least one selected from the group consisting of a type of a hole, a shape and a property of the hole, a shape and a property of a hazard, a shape and a property of an obstacle, and a shape and a property of a message board on which a character string is displayed.

3. The virtual golf system according to claim 1, wherein:
when the original course data including the advertisement data has been selected by the second user, the management device calculates a reward amount commensurate with an advertisement fee as a reward amount to be paid to the first user, a third user to whom ownership of the original course data has been transferred from the first user, or a fourth user to whom a right to use the original course data has been granted by the first user.

4. The virtual golf system according to claim 1, wherein:
the design information includes information indicative of a location where the advertisement is to be placed.

5. The virtual golf system according to claim 1, wherein:
when the original course data has been selected by the second user, the management device awards a point to the first user.

6. A management device that manages a course data group which includes a plurality of pieces of course data each representing a virtual golf course,
the management device adding, to course data among the pieces of course data, advertisement data representing an advertisement which is to be placed at a location on a virtual golf course or on an item on the virtual golf course and providing, to a simulation device, course data selected from the course data group by a user, the simulation device projecting, on a screen, a virtual golf course representing the selected course data and reproducing, on the screen, a trajectory of a golf ball corresponding to a shot hit by the user.

7. The management device according to claim 6, wherein:
the management device adds the advertisement data to the course data on the basis of advertisement placement information designated by another user who differs from the user.

8. The management device according to claim 7, wherein:
the advertisement placement information includes information indicative of a location where an advertisement is to be placed on the virtual golf course or an item where an advertisement is to be placed on the virtual golf course.

9. The management device according to claim 7, wherein:
when the course data including the advertisement data has been selected by the user, the management device calculates a reward amount commensurate with an advertisement fee as a reward amount to be paid to the another user.
